(19) United States
(12) Patent Application Publication
(10) Pub. No.: US 2021/0094311 A1
(43) Pub. Date: Apr. 1, 2021

(54) HIGH-VISCOSITY FLUID DELIVERY

(71) Applicant: HP INDIGO B.V., Amstelveen (NL)

(72) Inventors: Jonathan Nir, Ness Ziona (IL); Yossi Shachak, Ness Ziona (IL)

(73) Assignee: HP INDIGO B.V., Amstelveen (NL)

(21) Appl. No.: 16/603,802

(22) PCT Filed: Apr. 18, 2017
(86) PCT No.: PCT/EP2017/059206

§ 371 Date: Oct. 8, 2019

(51) Int. Cl. B41J 2/175; B41J 2/195; F04B 13/00; F04B 15/02; F04B 49/06; F04B 49/22; F04B 53/12

(52) U.S. Cl. CPC B41J 2/17596; B41J 2/195; F04B 13/00; F04B 15/02; F04B 2205/04; F04B 49/22; F04B 53/12; F04B 2201/0201; F04B 49/065

(57) ABSTRACT

The present disclosure provides a method and system for delivering a high-viscosity fluid 300. In an example, a reciprocating a piston pumps a high-viscosity fluid 300 through a one-way check valve 130 into a pump chamber 125. Responsive to receipt of a request for a dose of the high-viscosity fluid 300, an output valve 135 in the pump chamber 125 is opened, and the piston is reciprocated in order to eject a dose of the high-viscosity fluid 300 from the pump chamber 125 through the output valve 135.

### BACKGROUND

The printing fluid used in some commercial and industrial printing systems may be extremely viscous. In some examples, these high-viscosity printing fluids are provided in barrels, for extraction and provision to the print heads of printing systems. In order to achieve high-quality printing, accurate extraction and dosing of the high-viscosity printing fluid is desired.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram of an example pump system in a first position according to the present disclosure;

FIG. 2 is a schematic diagram of the example pump system of FIG. 1 in a second position;

FIG. 3 is a flow chart illustrating a first example of a method according the present disclosure;

FIG. 4 is a flow chart illustrating a second example of a method according to the present disclosure; and

FIG. 5 is a schematic diagram of a computer-readable storage medium according to an example.

### DETAILED DESCRIPTION

In commercial and industrial printing systems, high viscosity printing fluid is often provided in a barrel. A positive displacement piston pump may be used to extract the printing fluid from the barrel for delivery to the print heads of the printing system. Viscous printing fluids can contain a large percentage of trapped air.

Different batches of printing fluid, or even different samples of printing fluid within the same batch, may contain assorted levels of trapped air when compared to each other. Therefore, each sample of printing fluid has an undetermined concentration and density of printing fluid, which can hinder the accurate, and repeatable, extraction and dosing of the printing fluid to the print heads. Improved accuracy and repeatable extraction and dosing of printing fluid can be realised by examples of the systems and methods described according to the present disclosure.

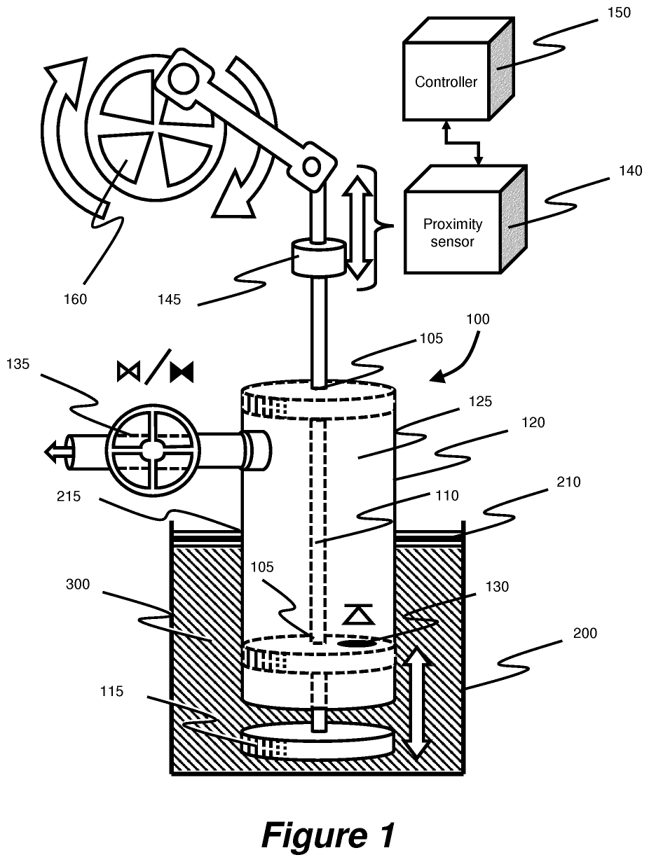

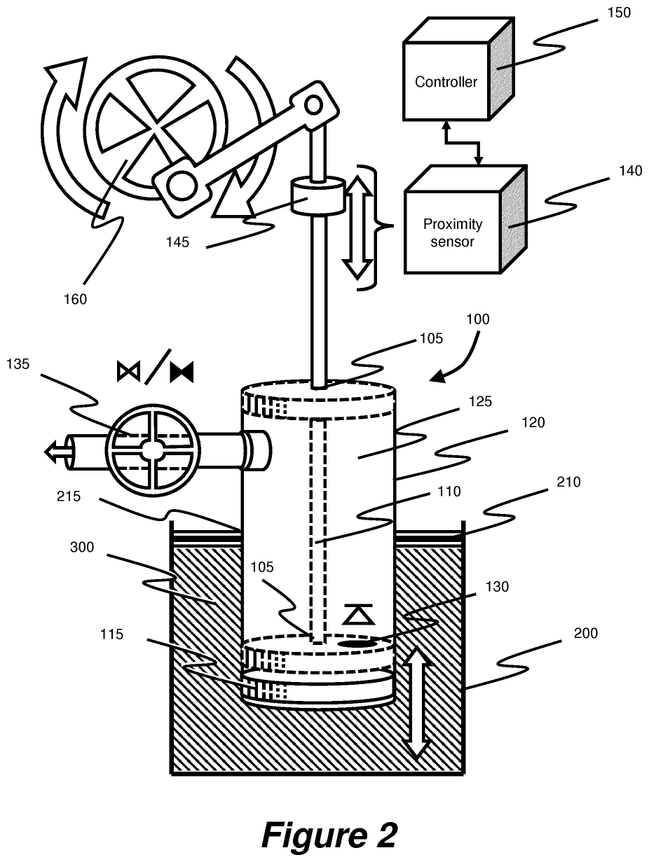

FIG. 1 shows an example of an extraction pump 100. The pump 100 comprises a reciprocating piston having a shaft 110 and a piston head 115 at one end of the shaft 110 and a pump body (or “cylinder”) 120. In the example shown in FIG. 1, the pump cylinder 120 comprises an upper lid at one end (shown at the top of the cylinder 120 in FIG. 1), a tubular body extending (downwards) from the upper lid, and a lower cap at the other end (shown at the bottom in FIG. 1) of the cylinder 120. The upper lid and lower cap are fixed in relation to one another, and a closed chamber 125 is defined by the space encapsulated by the upper lid, the tubular body, and the lower cap. Both the upper lid and the lower cap comprise fluid seals 105 which are adapted to allow the pump shaft 110 to pass through and reciprocate, without allowing passage of a fluid. The shaft 110 enters the pump cylinder 120 through the fluid seal 105 in the upper lid, and passes through the closed chamber 125 defined by the space inside the cylinder 120. The pump shaft 110 passes out of the lower cap through the corresponding fluid seal 105, and the piston head 115 is located at the end of the pump shaft 110 beyond the lower cap. In the example shown in FIG. 1, the tubular walls of the cylinder body extend beyond the lower cap and are adapted to receive the reciprocating piston head 115 for at least part of its reciprocating cycle. In the examples shown in FIG. 1 and FIG. 2, the length of the internal chamber 125 is longer than the extended cylinder body below the lower cap, and the length of the reciprocating motion of the pump shaft 110 and the piston head 115.

The pump 100 comprises two valves within the cylinder 120, a one-way check valve 130 and a controllable flow valve 135. In the example in FIG. 1, the check valve 130 is located in the lower cap of the cylinder 120 and acts as a one-way input valve configured to allow fluid to flow from the outside of the cylinder 120 into the chamber 125. The controllable flow valve 135 is located at the distal end to the input valve 130 and acts as an outlet, adjustable between an open position wherein fluid can flow through it to exit the chamber 125, and a closed position wherein fluid cannot flow through it.

In use, the pump 100 is positioned inside a vessel containing a printing fluid 300. In one example, and as shown in FIG. 1 and FIG. 2, the vessel is a barrel 200. When extracting highly viscous material from a vessel, owing to the relatively slow flow of the material being pumped, the pump will begin to draw in air as the highly viscous fluid fails to equalise or settle after extraction of fluid. In order to address this, and to ensure the pump does not draw in air, the barrel 200 may comprise a follower-plate 210. The follower-plate is a disc which sits atop the fluid 300 inside the barrel 200, and has an orifice 215 in the top to allow the pump 100 to pass through into the fluid 300. The follower-plate 210 fits tightly with the inner wall of the barrel 200 and the pump 100 by way of inner and outer rims of soft sealing lips. As the fluid 300 is extracted from the barrel 200 by the pump 100, the follower-plate 210 is lowered carefully at a corresponding rate so that the fluid 300 tends to surround the intake of the pump 100, whereby a reduced amount of air is extracted. However, whilst the follower-plate 210 can limit air from outside of the printing fluid being extracted by the pump 100, this fails to address the issue of air that may already be trapped inside the viscous printing fluid. In examples according to the present disclosure, issues arising due to printing fluid density variance can be ameliorated by pre-loading the printing fluid 300, under pressure, in the closed pump chamber 125, to reduce the volume of trapped air, thus achieving a more homogenous density of the printing fluid 300.

The pump 100 is inserted into a barrel 200 containing printing fluid 300 as shown in FIG. 1 and FIG. 2, and, initially, the flow valve (or output valve) 135 is closed. The pump 100 operates by reciprocating the pump shaft 110 and piston head 115 into and out of the extended end of the cylinder 120, causing the piston head 115 to “scoop” printing fluid 300 towards, and into, the check valve (input valve) 130. The reciprocating distance of the pump shaft 110 ensures that the piston head 115 travels beyond the end of the extended cylinder body so as to capture more fluid 300 from the barrel 200. On an up-stroke of the shaft 110 and piston head 115, the piston head 115 drives printing fluid 300 into the space defined by the extended cylinder body, and through the input valve 130 into the closed chamber 125 inside the cylinder 120. On a down-stroke of the shaft 110 and piston head 115, the piston head 115 is driven back into the printing fluid 300, beyond the extended cylinder body, so that the piston head 115 is once more covered by printing fluid 300 in preparation for the next pump cycle. The pump continues in this cycle (shown in FIG. 1 and FIG. 2) pumping printing fluid 300 into the closed chamber 125 through the input valve 130.

Whilst the output valve 135 is closed, and printing fluid 300 is pumped into the pump chamber 125, the pressure of the printing fluid 300 inside the chamber 125 increases. As the pressure of the printing fluid 300 increases, the trapped air inside the printing fluid 300 is compressed, and the volume of trapped air is reduced. By compressing the trapped air, the pump 100 creates a printing fluid 300, which is relatively incompressible compared to air, with a more homogenous density. In one example, the printing fluid 300 is compressed inside the chamber 125 to 250 bar.

In one example, once the pressure of the printing fluid 300 inside the chamber 125 reaches a predetermined level, the output valve 135 is opened, and the reciprocating shaft 110 and piston head 115 are cycled through a single stroke, pumping out a dose of highly pressurised fluid within the chamber 125 through the output valve 135. The pressure inside the chamber 125 may be monitored using a pressure sensor (not shown).

In an alternative example, the output valve 135 is opened when dosing is requested by the printing system, and the reciprocating shaft 110 and piston head 115 are cycled through a single stroke, pumping out a dose of the highly pressurised fluid from within the chamber 125 through the output valve 135. The longer the period between a request for printing fluid from the printing system, the greater the density of the printing fluid 300 inside the chamber 125. However, whilst the printing system does not request printing fluid 300, then the pressure of the printing fluid 300 inside the chamber 125 will increase until an equilibrium with the pump engine is reached. In one example, when equilibrium is reached the pump shaft 110 and piston head 115 will no longer be able to continue their reciprocating movement, and the printing fluid 300 will have reached its maximum (i.e. equilibrium) density for the system. In other examples, the pump 100 may maintain its reciprocating motion, but no printing fluid 300 will be pumped through the input valve 130 owing to the pressure of the printing fluid 300 inside. In further examples, it is anticipated that in light of the comparative speeds of the pump 100 and the estimated frequency of request for printing fluid 300, that pump 100 will complete, over time, more ‘compression’ strokes (i.e. whilst the output valve 135 is closed) than ejection strokes (i.e. whilst the output valve 135 is open). Therefore, the printing fluid 300 will be maintained under pressure (i.e. compressed) within the pump chamber 125 until requested. In one example, the reciprocating frequency of the pump 100 is such that more than one reciprocating stroke of the pump shaft 110 and piston head 115 will be completed between each request for printing fluid 300 and subsequent expulsion stroke of the pump shaft 110. Therefore, in this example, the pump 100 keeps running, pumping the printing fluid 300 into the chamber 125 until either the printing fluid 300 is requested by the printing system, or the pump 100 reaches an equilibrium pressure with the pre-loaded fluid 300 in the pump chamber 125.

In either of the examples described above, when either a predetermined pressure is reached, or a request for printing fluid is received, the pump 100 opens up the output valve 135 and cycles the pump shaft 110 through one stroke. In this manner, a single dose of printing fluid 300 is ejected from the chamber 125, regardless of the starting position of the pump shaft 110. The greater the pressure of the printing fluid 300 inside the chamber 125, the more accurate the dose of printing fluid 300 to the printing system since more of the trapped air has been compressed. It is anticipated that the high-viscosity of the printing fluid 300 will mitigate any expansion of air in the compressed fluid when the output valve 135 is opened, and the printing fluid 300 will be driven from the chamber 125 by the reciprocating motion of the pump, and not the expansion of any trapped air.

In some examples, the pump shaft 110 is equipped with a position sensor configured to collect and relay position data identifying the position of the pump shaft 110 within its cycle to a programmable logic controller 150. In some examples, and as shown in FIG. 1 and FIG. 2, the position sensor incorporates a metal ring 145 around the reciprocating pump shaft 110, wherein the metal ring 145 is detectable by a proximity sensor 140 in the vicinity of the pump shaft 110.

The controller 150 is communicatively coupled to, and adapted to control, the proximity sensor 140, the output valve 135 and a pump motor 160. The controller 150 is thereby able to monitor the position of the pump shaft 110 throughout its reciprocating cycle, control the reciprocating motion of the pump shaft 110 through the motor 160, and open and close the outlet valve 135 as desired. The controller 150 may provide a measured dose of printing fluid 300 either when a pre-determined pressure has been achieved, or when a demand for printing fluid 300 has been received from the printing system.

The controller 150 allows the print system 100 to provide printing fluid 300 at a more homogenous density, and of a more certain volume, by pre-loading (i.e. pressuring) the printing fluid 300 inside the closed chamber 125 before being driven through the output valve 135 at the appropriate time. The position data obtained from the proximity sensor 140, identifying the position of the pump shaft 110, allows the pump 100 to operate as a “closed-loop” system, whereby the volume of fluid expelled through the output valve 135 is not monitored. Instead, when the outlet valve 135 is opened upon demand, by using the controller 150 to reciprocate the piston pump shaft 110 through a stroke, a more accurate amount of printing fluid 300 can be provided to the print heads. Each single stroke of the piston pump shaft 110 provides a more homogenous volume of printing fluid 300. In this manner, a more accurate dose of printing fluid 300 is ejected, regardless of the starting position of the pump shaft 110.

The present disclosure provides for a system and method of more accurately dosing a high-viscosity printing fluid 300. In one example, the presently disclosed systems and methods provide for dosing of high-viscosity printing fluid 300 with a mass variance of 1 gr per dose. In a further example, the presently disclosed systems and methods provide for dosing of high-viscosity printing fluid 300 with a mass variance of 0.5 gr per dose.

Owing to differences in pressure and consistency, the flow rate of the printing fluid 300 from the pump system 100 may be less accurate at the beginning or the end of the contents of the barrel 200. Therefore, in one example, the controller 150 is adapted to adjust the behaviour of the pump system 100 at the start and end of the contents of the barrel 200 in order to achieve a steady flow of printing fluid 300 throughout the entire volume of the barrel 200. The adapted behaviour helps minimise wastage, i.e. residual printing fluid 300 left in the barrel 200. In one example, during the first 4 to 5 strokes of the pump 100 inside the printing fluid 300, the amount of air inside the pump system 100 may be greater than during normal (mid-barrel) use. At these times, the pump shaft 110 and piston head 115 will move faster, and the density (and therefore volume) of the ink extracted and subsequently dosed to the print heads will be lower. The speed of the pump 100 cycle during these times may be monitored by the controller 150, and compensated for in order to improve the accuracy of the dosing.

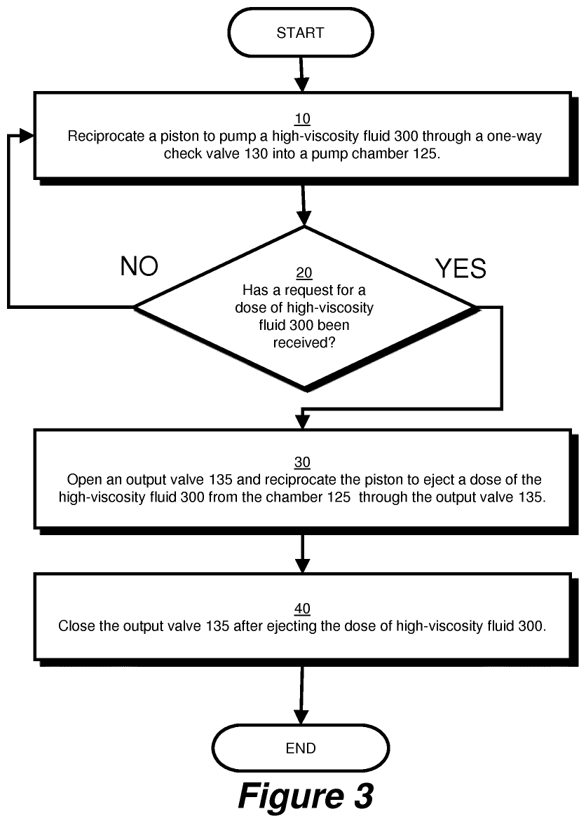

FIG. 3 shows a flowchart of an example method of accurately dosing high-viscosity fluids. At block 10, a piston is reciprocated to pump a high-viscosity fluid 300 through a one-way check valve 130 into a pump chamber 125. At block 20 a decision is made as to whether a request for a dose of the high-viscosity fluid 300 is received. If a request has not been received, the reciprocating piston action carried out at block 10 is repeated. If a request has been received, then at block 30 an output valve 135 is opened and the piston is reciprocated to eject a dose of the high-viscosity fluid 300 from the chamber 125 through the output valve 135. At block 40, the output valve is closed 135 after ejecting the dose of high-viscosity fluid 300.

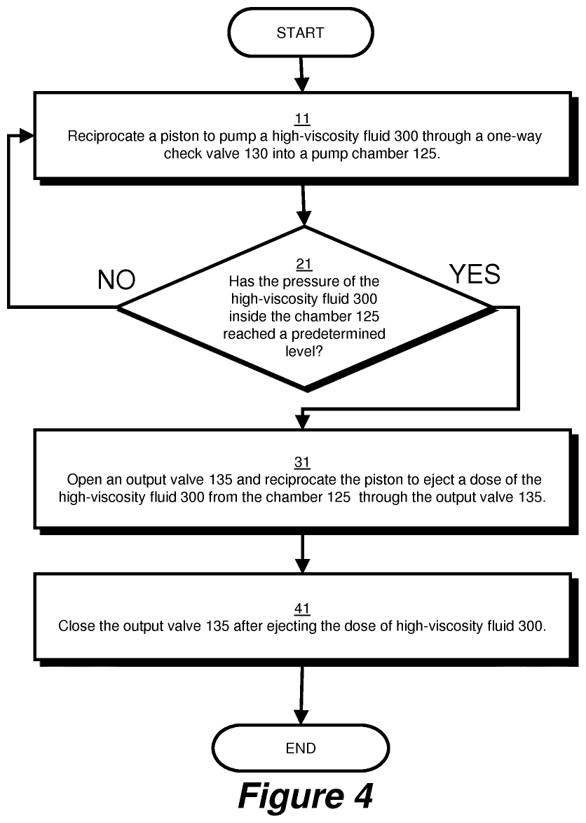

FIG. 4 shows a flowchart of another example method of accurately dosing high-viscosity fluids. At block 11, a piston is reciprocated to pump a high-viscosity fluid 300 through a one-way check valve 130 into a pump chamber 125. At block 21 a decision is made as to whether the pressure of the high-viscosity fluid 300 inside the chamber 125 reached a predetermined level. If the pressure of the high-viscosity fluid 300 inside the chamber 125 has not reached a predetermined level, the reciprocating piston action carried out at block 11 is repeated. If the pressure of the high-viscosity fluid 300 inside the chamber 125 has reached a predetermined level, then at block 31 an output valve 135 is opened and the piston is reciprocated to eject a dose of the high-viscosity fluid 300 from the chamber 125 through the output valve 135. At block 41, the output valve is closed 135 after ejecting the dose of high-viscosity fluid 300.

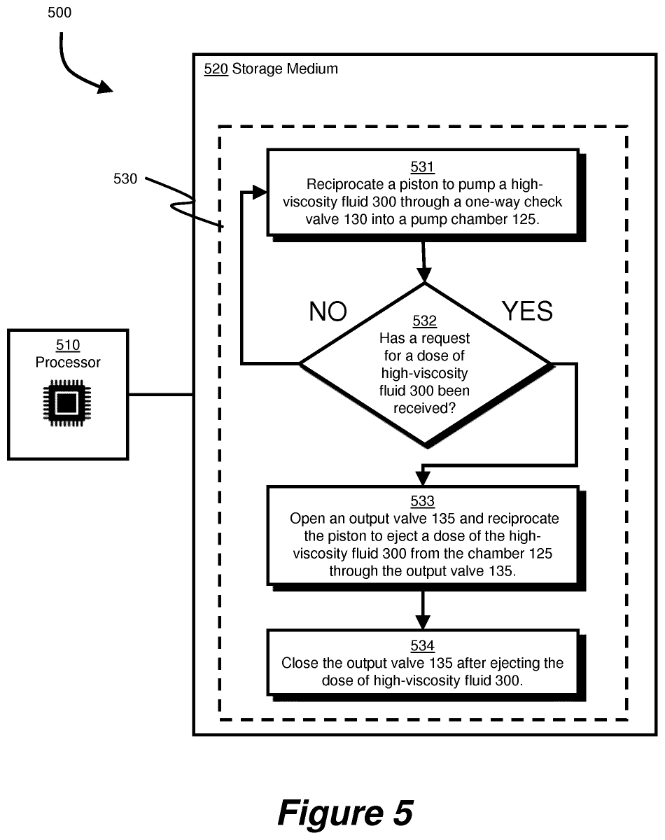

FIG. 5 shows a computer device 500 comprising at least one processor 510 and a non-transitory machine-readable storage medium 520 storing instructions 530 for execution by the processor 510. The computer device 500 may form part of a controller for a pump as described previously. The computer-readable storage medium 520 may comprise any machine-readable storage media, e.g. such as a memory and/or a storage device. Machine-readable storage media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc. In one case, the at least one processor 510 may be arranged to store instructions 520 in memory such as RAM to implement the methods and/or controller described above.

A first instruction 531 causes the processor 510 to reciprocate a piston to pump a high-viscosity fluid 300 through a one-way check valve 130 into a pump chamber 125. A second instruction 532 causes the processor 510 to check if a request for a dose of high-viscosity fluid 300 been received. If no such request has been received, the processor continues to reciprocate the piston. If a request for a dose of high-viscosity fluid 300 has been received, a third instruction 533 causes the processor 510 to open an output valve 135 and reciprocate the piston to eject a dose of the high-viscosity fluid 300 from the chamber 125 through the output valve 135. A fourth instruction 534 then causes the processor 510 to close the output valve 135 after ejecting the dose of high-viscosity fluid 300.

It is clear that other pump configurations may be used without deviating from the scope of the present disclosure. In some examples, the pump 100 may comprise more than one check-valve. For example, the piston head 115 may comprise a further check valve to aid the reciprocating motion of the piston head 115 through the printing fluid 300. The piston head 115 may be located within the cylinder 120, and used to draw instead of drive printing fluid 300 into the chamber 125.

In some examples, the pump shaft 110 is reciprocated through a single stroke in order to eject printing fluid 300 from the closed chamber 125, and in further examples, the printing fluid 300 is ejected from the chamber 125 during the upward stroke of the pump shaft 110 and piston head 115. During the downward stroke, no printing fluid 300 is driven into the chamber 125 and the input valve 130 prevents any printing fluid 300 from leaving the chamber 125. Therefore, printing fluid 300 will not be driven from the pump chamber 125 out of the output valve 135. However, it will be appreciated that the controller 150 may be configured to reciprocate the pump shaft 110 through other distances, less than a full stroke, e.g. ¼ or ½ of an upward stroke, in order to eject printing fluid 300 from the chamber 125. Similarly, the controller 150 may be configured to reciprocate the pump shaft 110 through more than a full stroke, e.g. 1½, 2 or 3½ cycles of the upward stroke. In each example, the controller 150 is configured to reciprocate the pump shaft 110 through a specific and measured distance in order to expel printing fluid 300 from the chamber 125. As discussed above, in some examples, the pump 100 will reciprocate the pump shaft 110 through a greater length of compression strokes compared to expulsion strokes, whatever the configured stroke length is.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method of delivering a high-viscosity fluid 300, the method comprising:
reciprocating a piston to pump a high-viscosity fluid through a one-way check valve into a pump chamber;
responsive to receiving a request for a dose of the high-viscosity fluid, opening an output valve in the pump chamber and reciprocating the piston to eject a dose of the high-viscosity fluid from the pump chamber through the output valve; and
closing the output valve after ejecting the dose.

2. The method according to claim 1, wherein the piston is reciprocated through a specific measured distance to eject the high-viscosity fluid from the chamber through the output valve.

3. The method according to claim 2, wherein the piston is reciprocated through exactly one stroke to eject the high-viscosity fluid from the chamber through the output valve.

4. The method according to claim 1 wherein the piston completes more strokes whilst the output valve is closed than whilst the output valve is open.

5. The method according to claim 4, wherein the piston is reciprocated through at least two full cycles before the output valve is opened.

6. The method according to claim 1 wherein the printing fluid is maintained under pressure in the pump chamber.

7. A controller for a reciprocating pump, the controller adapted to:
reciprocate a piston to pump a high-viscosity fluid through a one-way check valve into a chamber;
in response to receiving a request for the high-viscosity fluid, open an output valve and reciprocate the piston to eject a dose of the high-viscosity fluid from the chamber through the output valve; and
close the output valve after ejecting the dose.

8. The controller according to claim 7, adapted reciprocate the piston through a specific measured distance to eject the high-viscosity fluid from the chamber through the output valve.

9. The controller according to claim 8, adapted to reciprocate the piston through exactly one stroke in order to eject a dose of high-viscosity fluid from the chamber through the output valve.

10. The controller according to claim 7 adapted to communicate with a proximity sensor to register the location of the piston in order to reciprocate the piston through a specific measured distance to eject the high-viscosity fluid from the chamber through the output valve.

11. The controller according to claim 7, wherein the controller is adapted to reciprocate the piston through more strokes whilst the output valve is closed than whilst the output valve is open.

12. The controller according to claim 11, wherein the controller is adapted to reciprocate the piston through at least two full cycles before the output valve is opened.

13. The controller according to claim 7, adapted to maintain the printing fluid under pressure in the pump chamber.

14. A pump comprising:
a cylinder defining a closed chamber comprising a one-way check valve and an outlet valve;
a piston drivable by a motor to reciprocate within the cylinder, the one-way check valve positioned between the piston and chamber; and
a controller for controlling reciprocation of the piston and being arranged to:
reciprocate the piston to pump a high-viscosity fluid through the one-way check valve into the chamber;
in response to receiving a request for the high-viscosity fluid, open the output valve and reciprocate the piston to pump high-viscosity fluid into the chamber and thereby eject a dose of the high-viscosity fluid from the chamber through the output valve; and
close the output valve after ejecting the dose.

15. A non-transitory computer readable medium encoded with instructions that, when executed by a processor, cause the processor to instruct a controller to:
reciprocate a piston to pump a high-viscosity fluid through a one-way check valve into a pump chamber;
responsive to receiving a request for a dose of the high-viscosity fluid, open an output valve in the pump chamber and reciprocate the piston to eject a dose of the high-viscosity fluid from the pump chamber through the output valve; and
close the output valve after ejecting the dose.
